(19) United States
(12) Patent Application Publication
(10) Pub. No.: US 2023/0257519 A1
(43) Pub. Date: Aug. 17, 2023

(54) LIQUID CRYSTAL POLYESTER RESIN, MOLDED ARTICLE, AND ELECTRICAL/ELECTRONIC COMPONENT

(71) Applicant: ENEOS Corporation, Tokyo (JP)

(72) Inventors: Hiroshi MATSUURA, Tokyo (JP); Masaki NOGUCHI, Tokyo (JP); Yumiko NOBORI, Tokyo (JP); Yoshihiro KUMAGAI, Tokyo (JP)

(73) Assignee: ENEOS Corporation, Tokyo (JP)

(21) Appl. No.: 18/006,355

(22) PCT Filed: Jul. 20, 2021
(86) PCT No.: PCT/JP2021/027083

§ 371 Date: Jan. 20, 2023

(30) Foreign Application Priority Data
Jul. 21, 2020 (JP) 2020-124628

(51) Int. Cl. C08G 63/60

(52) U.S. Cl. CPC C08G 63/605; C08G 2250/00

(57) ABSTRACT

The invention provides a liquid crystal polyester resin which not only has a low-dielectric tangent, but also is excellent in balance between heat resistance and processing stability. The liquid crystal polyester resin comprises: a structural unit (I) derived from an aromatic hydroxycarboxylic acid; a structural unit (II) derived from an aromatic diol compound; and a structural unit (III) derived from an aromatic dicarboxylic acid, wherein the structural unit (I) contains a structural unit (IA) derived from 6-hydroxy-2-naphthoic acid, the structural unit (III) contains a structural unit (IIIA) derived from isophthalic acid and a structural unit (IIIB) derived from 2,6-naphthalenedicarboxylic acid, the dielectric tangent at a measurement frequency of 10 GHz is 1.50×10⁻³ or less, the melting point is 290° C. or more, and the difference in temperature between the melting point and the crystallization point is 30° C. or more.

### BACKGROUND OF THE INVENTION

### Field of the Invention

The present invention relates to a liquid crystal polyester resin, and more specifically relates to a liquid crystal polyester resin having a low-dielectric tangent, a molded article including the liquid crystal polyester resin, and an electrical/electronic component including the molded article.

### Background Art

In recent years, according to increases in amounts of information and communications in the field of communication, use of signals having frequencies in the high frequency band, for electronic devices, communication devices, and the like, has been increased, and in particular, use of signals having frequencies in the gigahertz (GHz) band, frequencies of 10⁹ Hz or more, has been actively performed. For example, the high frequency band, as the GHz band, has been used in the automobile field. Specifically, high frequencies of 76 to 79 GHz, and 24 GHz have been used respectively in millimeter wave radars and quasi millimeter wave radars to be mounted for collision prevention of automobiles, and are expected to become further popular from now.

However, according to increases in frequencies of signals to be used, there is caused deterioration in qualities of output signals, which can lead to false recognition of information, namely, an increase in transmission loss. While the transmission loss is configured from the conductor loss due to conductors and the dielectric loss due to resins for insulation, constituting electrical/electronic components, such as boards in electronic devices or communication devices, the conductor loss is in proportion to the 0.5th power of the frequency to be used and the dielectric loss is in proportion to the 1st power of the frequency and thus the effect by the dielectric loss is very large in the high frequency band, in particular, the GHz band. Since the dielectric loss is increased also in proportion to the dielectric tangent of resins, there is a demand for a resin having a low-dielectric tangent for prevention of information degradation. For example, Patent Literature 1 has proposed, as a liquid crystal polyester resin low in dielectric loss, a liquid crystal polyester resin containing a structural unit derived from p-hydroxybenzoic acid, a structural unit derived from 6-hydroxy-2-naphthoic acid, a structural unit derived from 4,4′-dihydroxybiphenyl, and 2,6-naphthalenedicarboxylic acid at a specified compositional ratio.

Resins constituting electrical/electronic components are required to have high heat resistance against heating during molding, and furthermore molded articles produced with such resins are required to have high heat resistance against heating and processing with solders or the like. In view of such challenges, Patent Literature 2 and 3 each have proposed, as such a liquid crystal polyester resin excellent in heat resistance and the like, a liquid crystal polyester resin containing a structural unit derived from 6-hydroxy-2-naphthoic acid, a structural unit derived from 4,4′-dihydroxybiphenyl, and 2,6-naphthalenedicarboxylic acid at a specified compositional ratio.

### CITATION LIST

### Patent Literature

[Patent Literature 1] JP 2006-1990 A
[Patent Literature 2] JP 2004-244452 A
[Patent Literature 3] JP 2006-225642 A

### SUMMARY OF THE INVENTION

### Technical Problem

However, the present inventors have found that, even if the liquid crystal polyester resin proposed in each of Patent Literature 1 to 3 is used, a liquid crystal polyester resin which not only has a sufficient low-dielectric tangent, but also is excellent in balance between heat resistance and processing stability cannot be obtained.

The present inventors have made intensive studies in order to solve the above problems, and as a result, have found that a liquid crystal polyester resin which not only has a low-dielectric tangent, but also is excellent in balance between heat resistance and processing stability is obtained by regulating the melting point and the difference in temperature between the melting point and the crystallization point in a liquid crystal polyester resin containing a structural unit derived from 6-hydroxy-2-naphthoic acid, a structural unit derived from an aromatic diol compound, a structural unit derived from isophthalic acid, and a structural unit derived from 2,6-naphthalenedicarboxylic acid.

Accordingly, an object of the present invention is to provide a liquid crystal polyester resin which not only has a low-dielectric tangent, but also is excellent in balance between heat resistance and processing stability. Another aspect of the present invention is to provide a molded article including the liquid crystal polyester resin and an electrical/electronic component including the molded article.

### Solution to Problem

The liquid crystal polyester resin according to the present invention comprises:

a structural unit (I) derived from an aromatic hydroxycarboxylic acid;

a structural unit (II) derived from an aromatic diol compound; and

a structural unit (III) derived from an aromatic dicarboxylic acid, wherein

the structural unit (I) contains a structural unit (IA) derived from 6-hydroxy-2-naphthoic acid,

the structural unit (III) contains a structural unit (IIIA) derived from isophthalic acid and a structural unit (IIIB) derived from 2,6-naphthalenedicarboxylic acid,

the dielectric tangent at a measurement frequency of 10 GHz is 1.50×10⁻³ or less,

the melting point is 290° C. or more, and

the difference in temperature between the melting point and the crystallization point is 30° C. or more.

In an aspect of the present invention, the melting point of the liquid crystal polyester resin is preferably 340° C. or less.

In an aspect of the present invention, preferably, the structural unit (I) optionally further contains a structural unit (IB) derived from p-hydroxybenzoic acid, and

compositional ratios (mol %) of the structural units (I) to (III) satisfies the following conditions:

36% by mol≤structural unit (IA)≤74% by mol

0% by mol≤structural unit (IB)≤4% by mol

11% by mol≤structural unit (II)≤32% by mol

1% by mol≤structural unit (IIIA)≤7% by mol

10% by mol≤structural unit (IIIB)≤25% by mol

In an aspect of the present invention, preferably, the structural unit (I) is a structural unit (IA) derived from 6-hydroxy-2-naphthoic acid,

the structural unit (III) contains a structural unit (IIIA) derived from isophthalic acid and a structural unit (IIIB) derived from 2,6-naphthalenedicarboxylic acid, and

the compositional ratios (mol %) of the structural units (I) to (III) satisfies the following conditions:

44% by mol≤structural unit (IA)≤72% by mol

14% by mol≤structural unit (II)≤28% by mol

2% by mol≤structural unit (IIIA)≤6% by mol

12% by mol≤structural unit (IIIB)≤22% by mol.

In an aspect of the present invention, preferably, the structural unit (I) contains a structural unit (IA) derived from 6-hydroxy-2-naphthoic acid and a structural unit (IB) derived from p-hydroxybenzoic acid,

the structural unit (III) contains a structural unit (IIIA) derived from isophthalic acid and a structural unit (IIIB) derived from 2,6-naphthalenedicarboxylic acid, and

the compositional ratios (mol %) of the structural units (I) to (III) satisfies the following conditions:

39% by mol≤structural unit (IA)≤71% by mol

0% by mol<structural unit (IB)≤3% by mol

13% by mol≤structural unit (II)≤30% by mol

2% by mol≤structural unit (IIIA)≤6% by mol

11% by mol≤structural unit (IIIB)≤24% by mol.

In an aspect of the present invention, the structural unit (II) derived from an aromatic diol compound is preferably a structural unit derived from 4,4′-dihydroxybiphenyl.

The molded article according to the present invention includes the liquid crystal polyester resin, and is preferably fibrous.

The molded article according to the present invention includes the liquid crystal polyester resin, and is preferably an injection molded article.

The electrical/electronic component according to the present invention includes the molded article.

### Advantageous Effects of Invention

According to the present invention, a liquid crystal polyester resin which not only has a low-dielectric tangent, but also is excellent in balance between heat resistance and processing stability can be realized. In other words, the liquid crystal polyester resin of the present invention can be used to thereby not only enhance processing stabilities such as injection molding stability and spinning stability, but also enhance heat resistance against thermal processing of a molded article produced. Accordingly, in a case where the liquid crystal polyester resin, which is processing molded, is used in a product, deterioration in output signal quality can be prevented in an electrical/electronic device and a communication device in which a signal high in frequency is used.

### DETAILED DESCRIPTION OF THE INVENTION

### (Liquid Crystal Polyester Resin)

The liquid crystal polyester resin according to the present invention comprises a structural unit (I) derived from an aromatic hydroxycarboxylic acid, a structural unit (II) derived from an aromatic diol compound, and a structural unit (III) derived from an aromatic dicarboxylic acid. Furthermore, in the liquid crystal polyester resin, the structural unit (I) contains a structural unit (IA) derived from 6-hydroxy-2-naphthoic acid and preferably optionally further contains a structural unit (IB) derived from p-hydroxybenzoic acid, the structural unit (III) contains a structural unit (IIIA) derived from isophthalic acid and a structural unit (IIIB) derived from 2,6-naphthalenedicarboxylic acid, and the following particular properties (the dielectric tangent, the melting point, and the difference in temperature between the melting point and the crystallization point) are possessed.

The dielectric tangent (measurement frequency: 10 GHz) of the liquid crystal polyester resin according to the present invention is 1.50×10⁻³ or less, preferably 1.00×10⁻³ or less, more preferably 0.90×10⁻³ or less, further preferably 0.80×10⁻³ or less. The dielectric tangent of the liquid crystal polyester resin according to the present invention is in the numerical value range, and thus a molded article having a low-dielectric tangent can be produced and therefore, in the case of use as a product, deterioration in output signal quality can be prevented in an electrical/electronic device and a communication device in which a signal high in frequency is used.

Herein, the dielectric tangent at 10 GHz of the liquid crystal polyester resin can be measured with, for example, a network analyzer N5247A from Keysight Technologies, according to a split-post dielectric resonator method (SPDR method).

The lower limit value of the melting point of the liquid crystal polyester resin according to the present invention is 290° C. or more, preferably 295° C. or more, more preferably 300° C. or more, and the upper limit value thereof is preferably 340° C. or less, more preferably 335° C. or less, further preferably 330° C. or less. The melting point of the liquid crystal polyester resin according to the present invention is in the numerical value range and thus heat resistance against thermal processing of a molded article produced with the liquid crystal polyester resin can be enhanced.

The lower limit value of the crystallization point of the liquid crystal polyester resin according to the present invention is preferably 240° C. or more, more preferably 245° C. or more, and the upper limit value thereof is preferably 295° C. or less, more preferably 290° C. or less.

The lower limit value of the difference in temperature between the melting point and the crystallization point of the liquid crystal polyester resin according to the present invention (=“melting point (° C.)”-“crystallization point (° C.)”) is 30° C. or more, preferably 35° C. or more, more preferably 40° C. or more, and the upper limit value thereof is preferably 70° C. or less, more preferably 60° C. or less. The difference in temperature between the melting point and the crystallization point of the liquid crystal polyester resin according to the present invention is in the numerical value range and thus, when a liquid crystal polyester is melt-molded, a sufficient time can be taken until solidification of the liquid crystal polyester molten and the degree of freedom of setting of temperature conditions such as molding temperature can be increased. Accordingly, processing stabilities such as injection molding stability and spinning stability can be enhanced.

Herein, the melting point and the crystallization point of the liquid crystal polyester resin are each a value measured with a differential scanning calorimeter (DSC). Specifically, an exothermic peak top obtained in complete melting of the liquid crystal polyester resin by temperature rise from room temperature to 340 to 360° C. at a rate of temperature rise of 10° C./min and then temperature dropping to 30° C. at a rate of 10° C./min is defined as the crystallization point (Tc) and furthermore an endothermic peak top obtained in further temperature rise to 360° C. at a rate of 10° C./min is defined as the melting point (Tm).

The crystallinity of the liquid crystal polyester resin according to the present invention can be confirmed with, for example, a polarization microscope (trade name: BH-2) manufactured by OLYMPUS CORPORATION, equipped with a hot stage for microscopes (trade name: FP82HT) manufactured by METTLER TOLEDO, by heating and melting the liquid crystal polyester resin on a microscope heating stage and then observing the presence of optical anisotropy.

The lower limit value of the melt viscosity of the liquid crystal polyester resin according to the present invention, under conditions of a temperature corresponding to the melting point of the liquid crystal polyester resin, +20° C., and a shear speed of 100 s⁻¹, is preferably 20 Pa·s or more, more preferably 40 Pa·s or more, further preferably 50 Pa·s or more from the viewpoint of moldability, and the upper limit value thereof is 600 Pa·s or less, more preferably 350 Pa·s or less, further preferably 320 Pa·s or less, still more preferably 200 Pa·s or less.

Herein, the viscosity of the liquid crystal polyester resin can be measured with a capillary rheometer viscometer, according to JIS K7199.

In the liquid crystal polyester resin according to the present invention, the compositional ratios (mol %) of the structural units (I) to (III) preferably satisfies:

36% by mol≤structural unit (IA)≤74% by mol

0% by mol≤structural unit (IB)≤4% by mol

11% by mol≤structural unit (II)≤32% by mol

1% by mol≤structural unit (IIIA)≤7% by mol

10% by mol≤structural unit (IIIB)≤25% by mol.

Furthermore, in the liquid crystal polyester resin according to the present invention, in a case where the structural unit (I) derived from an aromatic hydroxycarboxylic acid contains only a structural unit (IA) derived from 6-hydroxy-2-naphthoic acid and contains no structural unit (IB) derived from p-hydroxybenzoic acid, the following conditions are more preferably satisfied:

44% by mol≤structural unit (IA)≤72% by mol

14% by mol≤structural unit (II)≤28% by mol

2% by mol≤structural unit (IIIA)≤6% by mol

12% by mol≤structural unit (IIIB)≤22% by mol.

In the liquid crystal polyester resin according to the present invention, in a case where the structural unit (I) contains both a structural unit (IA) derived from 6-hydroxy-2-naphthoic acid and a structural unit (IB) derived from p-hydroxybenzoic acid, the following conditions are more preferably satisfied:

39% by mol≤structural unit (IA)≤71% by mol

0% by mol<structural unit (IB)≤3% by mol

13% by mol≤structural unit (II)≤30% by mol

2% by mol≤structural unit (IIIA)≤6% by mol

11% by mol≤structural unit (IIIB)≤24% by mol.

The liquid crystal polyester resin according to the present invention, in which the compositional ratios (mol %) of the structural units (I) to (III) satisfies the above conditions, thus not only has a low-dielectric tangent, but also is excellent in balance between heat resistance and processing stability.

The compositional ratio of the structural unit (II) and the compositional ratio of the structural unit (III) in the liquid crystal polyester resin according to the present invention are substantially equivalent to each other ((structural unit (II)≈structural unit (III)). The lower limit value of the total of the structural units (I) to (III) relative to the entire structural unit of the liquid crystal polyester resin is preferably 90% by mol or more, more preferably 95% by mol or more, further preferably 99% by mol or more, and the upper limit value thereof is preferably 100% by mol or less.

Hereinafter, each structural unit contained in the liquid crystal polyester resin is described in detail.

(Structural Unit (I) Derived from Aromatic Hydroxycarboxylic Acid)

The liquid crystal polyester resin contains a structural unit (I) derived from an aromatic hydroxycarboxylic acid. The structural unit (I) derived from an aromatic hydroxycarboxylic acid contains a structural unit (IA) derived from 6-hydroxy-2-naphthoic acid, represented by the following formula (IA). The compositional ratio (mol %) of the structural unit (IA) in the liquid crystal polyester resin is preferably 36% by mol or more and 74% by mol or less. The lower limit value of the compositional ratio (mol %) of the structural unit (IA) is preferably 39% by mol or more, more preferably 44% by mol or more, further preferably 50% by mol or more, and the upper limit value thereof is preferably 72% by mol or less, more preferably 71% by mol or less, further preferably 70% by mol or less, from the viewpoint that the liquid crystal polyester resin is reduced in dielectric tangent, enhanced in heat resistance and enhanced in processing stability.

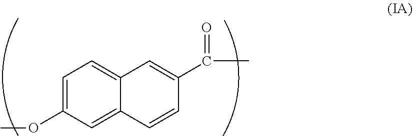

Examples of a monomer imparting the structural unit (IA) include 6-hydroxy-2-naphthoic acid (HNA, the following formula (1)), and acetylated products, ester derivatives and acid halides thereof.

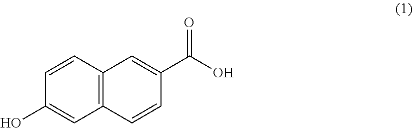

Furthermore, the structural unit (I) derived from an aromatic hydroxycarboxylic acid may contain a structural unit (IB) derived from p-hydroxybenzoic acid, represented by the following formula (IB). The compositional ratio (mol %) of the structural unit (IB) in the liquid crystal polyester resin is preferably 0% by mol or more and 4% by mol or less. In a case where the structural unit (IB) is contained, the lower limit value of the compositional ratio (mol %) of the structural unit (IB) is preferably more than 0% by mol, more preferably 0.5% by mol or more, and the upper limit value thereof is preferably 3% by mol or less, more preferably 2% by mol or less, from the viewpoint that the liquid crystal polyester resin is reduced in dielectric tangent, enhanced in heat resistance and enhanced in processing stability.

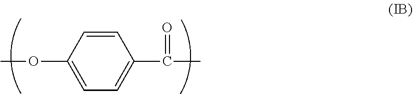

Examples of a monomer imparting the structural unit (IB) include p-hydroxybenzoic acid (HBA, the following formula (2)), and acetylated products, ester derivatives and acid halides thereof.

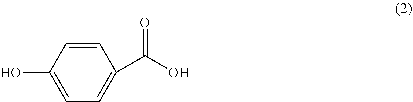

(Structural Unit (II) Derived from Aromatic Diol Compound)

The liquid crystal polyester resin contains a structural unit (II) derived from an aromatic diol compound, and the compositional ratio (mol %) of the structural unit (II) in the liquid crystal polyester resin is preferably 11% by mol or more and 32% by mol or less. The lower limit value of the compositional ratio (mol %) of the structural unit (II) is preferably 13% by mol or more, more preferably 14% by mol or more, and the upper limit value thereof is preferably 30% by mol or less, more preferably 28% by mol or less, from the viewpoint that the liquid crystal polyester resin is reduced in dielectric tangent, enhanced in heat resistance and enhanced in processing stability.

In one embodiment, the structural unit (II) is represented by the following formula (II).

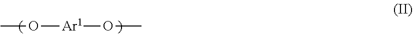

In the formula, Ar¹ is selected from the group consisting of a phenyl group, a biphenyl group, a 4,4′-isopropylidenediphenyl group, a naphthyl group, an anthryl group and a phenanthryl group each optionally having a substituent. In particular, a phenyl group and a biphenyl group are more preferable. Examples of the substituent include hydrogen, an alkyl group, an alkoxy group, and fluorine. The number of carbon atoms in the alkyl group is preferably 1 to 10, more preferably 1 to 5. A linear alkyl group or a branched alkyl group may be adopted. The number of carbon atoms in the alkoxy group is preferably 1 to 10, more preferably 1 to 5.

Examples of a monomer imparting the structural unit (II) include 4,4′-dihydroxybiphenyl (BP, the following formula (3)), hydroquinone (HQ, the following formula (4)), methylhydroquinone (MeHQ, the following formula (5)), 4,4′-isopropylidenediphenol (BisPA, the following formula (6)), and acylated products, ester derivatives and acid halides thereof. In particular, 4,4′-dihydroxybiphenyl (BP), and acylated products, ester derivatives and acid halides thereof are preferably used.

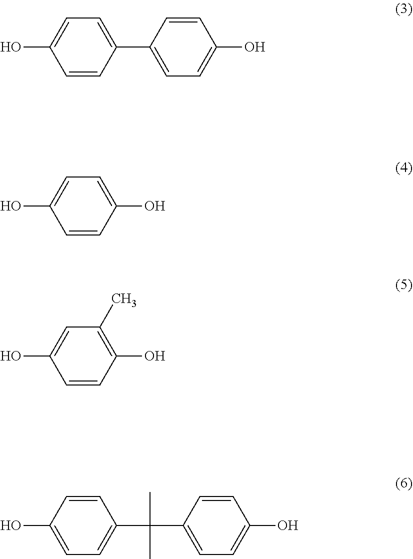

(Structural Unit (III) Derived from Aromatic Dicarboxylic Acid)

The liquid crystal polyester resin contains a structural unit (III) derived from an aromatic dicarboxylic acid. Furthermore, the structural unit (III) derived from an aromatic dicarboxylic acid contains a structural unit (IIIA) derived from isophthalic acid, represented by the following formula (IIIA). The compositional ratio (mol %) of the structural unit (IIIA) in the liquid crystal polyester resin is preferably 1% by mol or more and 7% by mol or less. The lower limit value of the compositional ratio (mol %) of the structural unit (IIIA) is preferably 2% by mol or more, and the upper limit value thereof is preferably 6% by mol or less, more preferably 5% by mol or less, from the viewpoint that the liquid crystal polyester resin is reduced in dielectric tangent, enhanced in heat resistance and enhanced in processing stability.

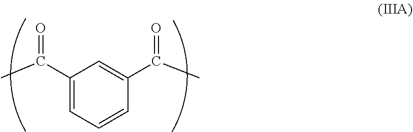

Examples of a monomer imparting the structural unit (IIIB) include isophthalic acid (IPA, the following formula (7)), and ester derivatives and acid halides thereof.

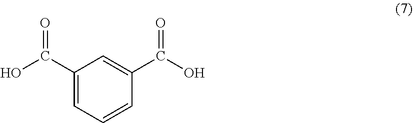

The structural unit (III) derived from an aromatic dicarboxylic acid contains a structural unit (IIIB) derived from 2,6-naphthalenedicarboxylic acid, represented by the following formula (IIIB). The compositional ratio (mol %) of the structural unit (IIIB) in the liquid crystal polyester resin is preferably 10% by mol or more and 25% by mol or less. The lower limit value of the compositional ratio (mol %) of the structural unit (IIIB) is preferably 11% by mol or more, more preferably 12% by mol or more, and the upper limit value thereof is preferably 24% by mol or less, more preferably 22% by mol or less, from the viewpoint that the liquid crystal polyester resin is reduced in dielectric tangent, enhanced in heat resistance and enhanced in processing stability.

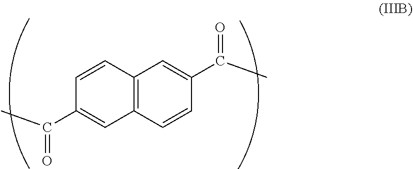

Examples of a monomer imparting the structural unit (IIIB) include 2,6-naphthalenedicarboxylic acid (NADA, the following formula (8)), and ester derivatives and acid halides thereof.

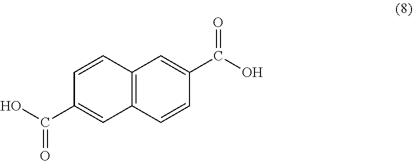

### (Method for Producing Liquid Crystal Polyester Resin)

The liquid crystal polyester resin according to the present invention can be produced by polymerizing monomers optionally imparting structural units (I) to (III), according to a conventionally known method such as melt polymerization, solid phase polymerization, solution polymerization and slurry polymerization. In one embodiment, the liquid crystal polyester resin according to the present invention can be produced by only melt polymerization. The liquid crystal polyester resin can also be produced by two-stage polymerization where a prepolymer is produced by melt polymerization and further is subjected to solid phase polymerization.

The melt polymerization is preferably performed under acetic acid reflux, by combining the monomers optionally imparting the structural units (I) to (III) by predetermined compounding so that the total reaches 100% by mol, and allowing 1.05 to 1.15 molar equivalents of acetic anhydride to be present based on the total hydroxyl group in the monomers, from the viewpoint of efficiently providing the liquid crystal polyester resin according to the present invention. The melt polymerization is preferably performed under reduced pressure. As the reaction conditions, the reaction temperature is preferably 200 to 380° C., more preferably 240 to 370° C., further preferably 260 to 360° C., and the ultimate pressure is preferably 0.1 to 760 Torr, more preferably 1 to 100 Torr, further preferably 1 to 50 Torr.

In a case where a polymerization reaction is performed at two stages of the melt polymerization and subsequent solid phase polymerization, a polymer obtained by the melt polymerization may be cooled and solidified and then pulverized into a powder or a flake. A polymer strand obtained by the melt polymerization may be pelletized into a pellet. Thereafter, a known solid phase polymerization method, for example, a method for heat-treating such a polymer at a temperature ranging from 200 to 350° C. under an atmosphere of an inert gas such as nitrogen or under vacuum for 1 to 30 hours is preferably selected. The solid phase polymerization may be performed with stirring or under still standing with no stirring.

A catalyst may or may not be used in the polymerization reaction. The catalyst used can be any conventionally known catalyst for polyester resin formation, and examples include metal salt catalysts such as potassium acetate, magnesium acetate, stannous acetate, lead acetate, sodium acetate, tetrabutyl titanate and antimony trioxide, and organic compound catalysts such as a nitrogen-containing heterocyclic compound such as N-methylimidazole. The amount of the catalyst used is not particularly limited, and is preferably 0.0001 to 0.1 parts by weight based on 100 parts by weight of the total monomer.

The polymerization reaction apparatus in the melt polymerization is not particularly limited, and a reaction apparatus for use in a general reaction of a high-viscosity fluid is preferably used. Examples of such a reaction apparatus include mixing apparatuses commonly used in resin kneading, for example, a stirring tank-type polymerization reaction apparatus having a stirring apparatus provided with a stirring blade having any shape such as an anchor, multiple-stage, spiral band or spiral shaft shape, or a modified shape thereof, or a kneader, a roll mill or a banbury mixer.

### (Molded Article)

The molded article according to the present invention includes the liquid crystal polyester resin, and the shape thereof is appropriately modified depending on the intended use and is not particularly limited, and can be, for example, a plate, sheet, or fibrous shape.

In one embodiment, the molded article can be fibrous. The fiber can be obtained by a conventionally known method, for example, a melt spinning method or a solution spinning method. The fiber may be made of only the liquid crystal polyester resin, or may be a mixture of the resin with other resin.

The molded article according to the present invention may further include a filler. Examples of the filler include carbon fiber, graphite, glass fiber, talc, mica, glass flake, clay, sericite, calcium carbonate, calcium sulfate, calcium silicate, silica, alumina, aluminum hydroxide, calcium hydroxide, black lead, potassium titanate, titanium oxide, fluorocarbon resin fiber, a fluorocarbon resin, barium sulfate, and various whiskers.

The molded article according to the present invention may include any resin other than the liquid crystal polyester resin without departing from the gist of the present invention. Examples include polyester resins such as polyethylene terephthalate, polyethylene naphthalate, polyarylate, polycyclohexylene dimethylene terephthalate, and polybutylene terephthalate, polyolefin resins such as polyethylene and polypropylene, cycloolefin polymers, vinyl resins such as polyvinyl chloride, (meth)acrylic resins such as polyacrylate, polymethacrylate and polymethyl methacrylate, polyphenylene ether resins, polyacetal resins, polyamide resins, imide resins such as polyimide and polyether imide, polystyrene resins such as polystyrene, high impact polystyrene, AS resins and ABS resins, thermosetting resins such as epoxy resins, cellulose resins, polyether ether ketone resins, fluororesins, and polycarbonate resins, and the molded article may include one, or two or more kinds of these resins.

The molded article according to the present invention may include other additive without departing from the gist of the present invention, and examples include a colorant, a dispersant, a plasticizer, an antioxidant, a curing agent, a flame retardant, a heat stabilizer, an ultraviolet absorber, an antistatic agent, and a surfactant.

The molded article according to the present invention can be obtained by subjecting a mixture containing the liquid crystal polyester resin and optionally other resin, other additive and/or the like to press molding, foam molding, injection molding, calendar molding, or punching molding. The mixture can be obtained by melt kneading the liquid crystal polyester resin and the like by use of a banbury mixer, a kneader, a one- or two-axis extruder, or the like.

### (Electrical/Electronic Component)

The electrical/electronic component according to the present invention includes the molded article (for example, injection molded article) including the liquid crystal polyester resin. Examples of the electrical/electronic component including the molded article include antennas, connectors for high-speed transmission, CPU sockets, circuit boards, flexible printed boards (FPCs), circuit boards for stacking, millimeter wave radars and quasi millimeter wave radars such as radars for collision prevention, RFID tags, capacitors, inverter components, covering materials for cables, insulation materials for secondary batteries such as lithium ion batteries, and speaker vibration plates, for use in electronic devices and communication devices such as ETC, GPS, wireless LAN and mobile phones.

### EXAMPLES

Hereinafter, the present invention is more specifically described with reference to Examples, but the present invention is not limited to these Examples.

### Production of Liquid Crystal Polyester Resin

### Example 1

Fifty two % by mol of 6-hydroxy-2-naphthoic acid (HNA), 24% by mol of 4,4′-dihydroxybiphenyl (BP), 5% by mol of isophthalic acid (IPA), and 19% by mol of 2,6-naphthalenedicarboxylic acid (NADA) were added to a polymerization vessel having a stirring blade, potassium acetate as a catalyst was loaded thereinto, depressurization of the polymerization vessel and nitrogen injection thereinto were performed three times, thereafter acetic anhydride (1.05 molar equivalent relative to a hydroxyl group) was further added, and the resultant was heated to 150° C. and subjected to an acetylation reaction in a reflux state for 2 hours.

After completion of the acetylation, the polymerization vessel in the state where acetic acid was distilled out was heated at 0.5° C./min until the melt zone temperature in the tank reached 330° C. Thereafter, the pressure was reduced over 30 minutes until the pressure in the system reached 50 Torr. After the stirring torque reached a predetermined value, nitrogen was introduced for conversion from a depressurized state to an ordinary pressure, and a polymer was extracted, and cooled and solidified. The polymer obtained was pulverized to a size so as to pass through a sieve having an aperture of 2.0 mm, and thus a polymer was obtained. When the melt viscosity at the melting point+20° C. and at 100 s⁻¹, of the polymer obtained, was in the range of 20 Pa·s or more and 600 Pa·s or less, the polymerization was completed. When the melt viscosity at the melting point+20° C. and at 100 s⁻¹, of the polymer obtained, was less than 20 Pa·s, the degree of polymerization was insufficient, and thus the temperature was raised to 300° C. so that the melt viscosity was in the range of 20 Pa·s or more and 600 Pa·s or less, thereafter retained for 4 hours for solid phase polymerization and such second polymerization was thus completed.

Thereafter, heat was released naturally at room temperature, and thus a polyester resin in the present invention was obtained. The polyester resin was heated and molten on a microscope heating stage and was confirmed based on the presence of optical anisotropy to exhibit crystallinity, by use of a polarization microscope (trade name: BH-2) manufactured by OLYMPUS CORPORATION, equipped with a hot stage for microscopes (trade name: FP82HT) manufactured by METTLER TOLEDO.

### Example 2

A polyester resin was obtained in the same manner as in Example 1 except that monomer charging was changed to 58% by mol of HNA, 21% by mol of BP, 5% by mol of IPA, and 16% by mol of NADA. Next, the crystallinity of the polyester resin was confirmed in the same manner as described above.

### Example 3

A polyester resin was obtained in the same manner as in Example 1 except that monomer charging was changed to 60% by mol of HNA, 20% by mol of BP, 3% by mol of IPA, and 17% by mol of NADA. Next, the crystallinity of the polyester resin was confirmed in the same manner as described above.

### Example 4

A polyester resin was obtained in the same manner as in Example 1 except that monomer charging was changed to 60% by mol of HNA, 20% by mol of BP, 4% by mol of IPA, and 16% by mol of NADA. Next, the crystallinity of the polyester resin was confirmed in the same manner as described above.

### Example 5

A polyester resin was obtained in the same manner as in Example 1 except that monomer charging was changed to 60% by mol of HNA, 20% by mol of BP, 6% by mol of IPA, and 14% by mol of NADA. Next, the crystallinity of the polyester resin was confirmed in the same manner as described above.

### Example 6

A polyester resin was obtained in the same manner as in Example 1 except that monomer charging was changed to 70% by mol of HNA, 15% by mol of BP, 3% by mol of IPA, and 12% by mol of NADA. Next, the crystallinity of the polyester resin was confirmed in the same manner as described above.

### Example 7

A polyester resin was obtained in the same manner as in Example 1 except that monomer charging was changed to 57% by mol of HNA, 1% by mol of p-hydroxybenzoic acid (HBA), 21% by mol of BP, 5% by mol of IPA, and 16% by mol of NADA. Next, the crystallinity of the polyester resin was confirmed in the same manner as described above.

### Example 8

A polyester resin was obtained in the same manner as in Example 1 except that monomer charging was changed to 48% by mol of HNA, 2% by mol of HBA, 25% by mol of BP, 3% by mol of IPA, and 22% by mol of NADA. Next, the crystallinity of the polyester resin was confirmed in the same manner as described above.

### Example 9

A polyester resin was obtained in the same manner as in Example 1 except that monomer charging was changed to 48% by mol of HNA, 2% by mol of HBA, 25% by mol of BP, 4% by mol of IPA, and 21% by mol of NADA. Next, the crystallinity of the polyester resin was confirmed in the same manner as described above.

### Example 10

A polyester resin was obtained in the same manner as in Example 1 except that monomer charging was changed to 48% by mol of HNA, 2% by mol of HBA, 25% by mol of BP, 5% by mol of IPA, and 20% by mol of NADA. Next, the crystallinity of the polyester resin was confirmed in the same manner as described above.

### Example 11

A polyester resin was obtained in the same manner as in Example 1 except that monomer charging was changed to 50% by mol of HNA, 2% by mol of HBA, 24% by mol of BP, 4% by mol of IPA, and 20% by mol of NADA. Next, the crystallinity of the polyester resin was confirmed in the same manner as described above.

### Example 12

A polyester resin was obtained in the same manner as in Example 1 except that monomer charging was changed to 54% by mol of HNA, 2% by mol of HBA, 22% by mol of BP, 3% by mol of IPA, and 19% by mol of NADA. Next, the crystallinity of the polyester resin was confirmed in the same manner as described above.

### Example 13

A polyester resin was obtained in the same manner as in Example 1 except that monomer charging was changed to 58% by mol of HNA, 2% by mol of HBA, 20% by mol of BP, 3% by mol of IPA, and 17% by mol of NADA. Next, the crystallinity of the polyester resin was confirmed in the same manner as described above.

### Comparative Example 1

A polyester resin was obtained in the same manner as in Example 1 except that monomer charging was changed to 50% by mol of HNA, 25% by mol of BP, and 25% by mol of NADA. Next, the crystallinity of the polyester resin was confirmed in the same manner as described above.

### Comparative Example 2

A polyester resin was obtained in the same manner as in Example 1 except that monomer charging was changed to 50% by mol of HNA, 25% by mol of BP, 10% by mol of IPA, and 15% by mol of NADA. Next, the crystallinity of the polyester resin was confirmed in the same manner as described above.

### Comparative Example 3

A polyester resin was obtained in the same manner as in Example 1 except that monomer charging was changed to 48% by mol of HNA, 2% by mol of HBA, 25% by mol of BP, and 25% by mol of NADA. Next, the crystallinity of the polyester resin was confirmed in the same manner as described above.

### Comparative Example 4

A polyester resin was obtained in the same manner as in Example 1 except that monomer charging was changed to 48% by mol of HNA, 2% by mol of HBA, 25% by mol of BP, 10% by mol of IPA, and 15% by mol of NADA. Next, the crystallinity of the polyester resin was confirmed in the same manner as described above.

### Comparative Example 5

A polyester resin was obtained in the same manner as in Example 1 except that monomer charging was changed to 60% by mol of HNA, 2% by mol of HBA, 19% by mol of BP, and 19% by mol of NADA. Next, the crystallinity of the polyester resin was confirmed in the same manner as described above.

### Comparative Example 6

A polyester resin was obtained in the same manner as in Example 1 except that monomer charging was changed to 38% by mol of HNA, 12% by mol of HBA, 25% by mol of BP, and 25% by mol of NADA. Next, the crystallinity of the polyester resin was confirmed in the same manner as described above.

### Comparative Example 7

A polyester resin was obtained in the same manner as in Example 1 except that monomer charging was changed to 27% by mol of HNA and 73% by mol of HBA. Next, the crystallinity of the polyester resin was confirmed in the same manner as described above.

### Production of Flat Plate-Shaped Test Piece

Each of the liquid crystal polyester resins obtained in Examples and Comparative Examples was heated and molten, and injection molded, under a condition of each melting point to the melting point+20° C., and thus each flat plate-shaped test piece of 30 mm×30 mm×0.4 mm was produced.

### <Measurement of Dielectric Tangent (10 GHz)>

The dielectric tangent (tan δ) in the in-plane direction of such each flat plate-shaped test piece produced above was determined by measuring the dielectric tangent at a frequency of 10 GHz with a network analyzer N5247A from Keysight Technologies, according to a split-post dielectric resonator method (SPDR method). The measurement results are shown in Table 1.

### <Measurements of Melting Point and Crystallization Point>

The melting point and the crystallization point of each of the liquid crystal polyester resins obtained in Examples and Comparative Examples were measured with a differential scanning calorimeter (DSC) manufactured by Hitachi High-Tech Science Corporation. First, an exothermic peak top obtained in complete melting of the liquid crystal polyester resin by temperature rise from room temperature to 340 to 360° C. at a rate of temperature rise of 10° C./min and then temperature dropping to 30° C. at a rate of 10° C./min was defined as the crystallization point (Tc) and furthermore an endothermic peak top obtained in further temperature rise to 360° C. at a rate of 10° C./min was defined as the melting point (Tm). The difference between the melting point and the crystallization point was calculated from the resulting melting point and crystallization point. The melting point, the crystallization point, and the difference between the melting point and the crystallization point were shown in Table 1.

### <Evaluation of Balance Between Heat Resistance and Processing Stability>

The balance between heat resistance and processing stability of each of the liquid crystal polyester resins obtained in Examples and Comparative Examples was evaluated according to the following criteria. A higher score in the evaluation criteria was more preferable, and a score of 3 points or more was determined as passing. The evaluation results were shown in Table 1.

### (Evaluation Criteria)

4: a melting point of 300° C. or more and 340° C. or less and a difference between melting point and crystallization point of 30° C. or more, and particularly excellent balance between heat resistance and processing stability.

3: a melting point of 290° C. or more and less than 300° C. and a difference between melting point and crystallization point of 30° C. or more, and excellent balance between heat resistance and processing stability.

2: a melting point of less than 290° C. or more than 340° C. or a difference between melting point and crystallization point of less than 30° C., and inferior balance between heat resistance and processing stability.

1: a melting point of less than 290° C. or more than 340° C. and a difference between melting point and crystallization point of less than 30° C., and particularly inferior balance between heat resistance and processing stability.

As clear from the results in Table 1, each of the liquid crystal polyester resins of Examples 1 to 13 was clearly low in dielectric tangent and excellent in balance between heat resistance and processing stability, as compared with a generalized liquid crystal polyester resin of Comparative Example 7. Furthermore, each of the liquid crystal polyester resins of Examples 1 to 13 was excellent in balance between heat resistance and processing stability also as compared with other compositional liquid crystal polyester resins of Comparative Examples 1 to 6.

### <Measurement of Melt Viscosity>

The melt viscosity (Pa·s) of each of the liquid crystal polyester resins obtained in Examples and Comparative Examples, at each melting point+20° C. at a shear speed of 100 S⁻¹, was measured with a capillary rheometer viscometer (Capilograph 1D manufactured by Toyo Seiki Seisaku-sho, Ltd.) and a capillary having an inner diameter of 1 mm, according to JIS K7199. The measurement results were shown in Table 1.

TABLE 1

| | | | | | | Performance evaluation | | | | | |
|---|---|---|---|---|---|---|---|---|---|---|---|
| | | | | | | | | | Difference in | Balance | |
| | | | | | | | | | temperature | between heat | |
| | Composition (mol %) | | | | | Dielectric | | | between melting | resistance | |
| | Structural units | | | | | tangent | Melting | Crystallization | point and | and | Melt |
| | (IA) | (IB) | (II) | (IIIA) | (IIIB) | (×10⁻³) | point | point | crystallization point | processing | viscosity |
| | HNA | HBA | BP | IPA | NADA | [10 GHz] | (° C.) | (° C.) | (° C.) | stability | (Pa · s) |
| Example 1 | 52 | 0 | 24 | 5 | 19 | 0.69 | 310 | 274 | 36 | 4 | 113 |
| Example 2 | 58 | 0 | 21 | 5 | 16 | 0.64 | 306 | 272 | 34 | 4 | 85 |
| Example 3 | 60 | 0 | 20 | 3 | 17 | 0.60 | 313 | 282 | 31 | 4 | 132 |
| Example 4 | 60 | 0 | 20 | 4 | 16 | 0.63 | 310 | 279 | 31 | 4 | 81 |
| Example 5 | 60 | 0 | 20 | 6 | 14 | 0.69 | 297 | 258 | 39 | 3 | 143 |
| Example 6 | 70 | 0 | 15 | 3 | 12 | 0.61 | 314 | 281 | 33 | 4 | 109 |
| Example 7 | 57 | 1 | 21 | 5 | 16 | 0.67 | 300 | 268 | 32 | 4 | 68 |
| Example 8 | 48 | 2 | 25 | 3 | 22 | 0.64 | 316 | 286 | 30 | 4 | 135 |
| Example 9 | 48 | 2 | 25 | 4 | 21 | 0.65 | 311 | 279 | 32 | 4 | 111 |
| Example 10 | 48 | 2 | 25 | 5 | 20 | 0.82 | 299 | 265 | 34 | 3 | 101 |
| Example 11 | 50 | 2 | 24 | 4 | 20 | 0.66 | 307 | 276 | 31 | 4 | 106 |
| Example 12 | 54 | 2 | 22 | 3 | 19 | 0.64 | 308 | 273 | 35 | 4 | 142 |
| Example 13 | 58 | 2 | 20 | 3 | 17 | 0.62 | 306 | 275 | 31 | 4 | 82 |
| Comparative | 50 | 0 | 25 | 0 | 25 | 0.55 | 341 | 320 | 21 | 1 | 88 |
| Example 1 | | | | | | | | | | | |
| Comparative | 50 | 0 | 25 | 10 | 15 | 0.83 | 283 | 246 | 37 | 2 | 82 |
| Example 2 | | | | | | | | | | | |
| Comparative | 48 | 2 | 25 | 0 | 25 | 0.57 | 332 | 315 | 17 | 2 | 89 |
| Example 3 | | | | | | | | | | | |
| Comparative | 48 | 2 | 25 | 10 | 15 | 0.88 | 273 | 236 | 37 | 2 | 100 |
| Example 4 | | | | | | | | | | | |
| Comparative | 60 | 2 | 19 | 0 | 19 | 0.65 | 320 | 293 | 27 | 2 | 113 |
| Example 5 | | | | | | | | | | | |
| Comparative | 38 | 12 | 25 | 0 | 25 | 0.89 | 296 | 269 | 27 | 2 | 172 |
| Example 6 | | | | | | | | | | | |
| Comparative | 27 | 73 | 0 | 0 | 0 | 1.88 | 281 | 246 | 35 | 2 | 139 |
| Example 7 | | | | | | | | | | | |

### Production/Evaluation of Molded Article

### (Formation of Test Piece)

Each of the liquid crystal polyester resins obtained in Examples 1, 3, and 12 was injection molded by an injection molding machine (manufactured by Rambaldi: Babyplast), and thus a dumbbell-shaped tensile test piece according to ISO527 was produced.

### (Measurements of Tensile Strength, Tensile Modulus, and Tensile Elongation)

The tensile test piece produced above was used to perform measurements of tensile strength (MPa) and tensile elongation (%) according to ISO 527.

TABLE 2

| | Tensile strength (MPa) | Tensile elongation (%) |
|---|---|---|
| Example 1 | 135 | 8.9 |
| Example 3 | 140 | 9.1 |
| Example 12 | 126 | 8.4 |

1. A liquid crystal polyester resin comprising:
a structural unit (I) derived from an aromatic hydroxycarboxylic acid;
a structural unit (II) derived from an aromatic diol compound; and
a structural unit (III) derived from an aromatic dicarboxylic acid,
wherein
the structural unit (I) contains a structural unit (IA) derived from 6-hydroxy-2-naphthoic acid,
the structural unit (III) contains a structural unit (IIIA) derived from isophthalic acid and a structural unit (IIIB) derived from 2,6-naphthalenedicarboxylic acid,
the dielectric tangent at a measurement frequency of 10 GHz is 1.50×10⁻³ or less,
the melting point is 290° C. or more, and
the difference in temperature between the melting point and the crystallization point is 30° C. or more.

2. The liquid crystal polyester resin according to claim 1, wherein the melting point is 340° C. or less.

3. The liquid crystal polyester resin according to claim 1, wherein
the structural unit (I) optionally further contains a structural unit (TB) derived from p-hydroxybenzoic acid, and
compositional ratios (mol %) of the structural units (I) to (III) satisfies the following conditions:
36% by mol≤structural unit (IA)≤74% by mol
0% by mol≤structural unit (TB)≤4% by mol
11% by mol≤structural unit (II)≤32% by mol
1% by mol≤structural unit (IIIA)≤7% by mol
10% by mol≤structural unit (IIIB)≤25% by mol.

4. The liquid crystal polyester resin according to claim 3, wherein
the structural unit (I) is a structural unit (IA) derived from 6-hydroxy-2-naphthoic acid,
the structural unit (III) contains a structural unit (IIIA) derived from isophthalic acid and a structural unit (IIIB) derived from 2,6-naphthalenedicarboxylic acid, and
the compositional ratios (mol %) of the structural units (I) to (III) satisfies the following conditions:
44% by mol≤structural unit (IA)≤72% by mol
14% by mol≤structural unit (II)≤28% by mol
2% by mol≤structural unit (IIIA)≤6% by mol
12% by mol≤structural unit (IIIB)≤22% by mol.

5. The liquid crystal polyester resin according to claim 3, wherein
the structural unit (I) contains a structural unit (IA) derived from 6-hydroxy-2-naphthoic acid and a structural unit (IB) derived from p-hydroxybenzoic acid,
the structural unit (III) contains a structural unit (IIIA) derived from isophthalic acid and a structural unit (IIIB) derived from 2,6-naphthalenedicarboxylic acid, and
the compositional ratios (mol %) of the structural units (I) to (III) satisfies the following conditions:
39% by mol≤structural unit (IA)≤71% by mol
0% by mol<structural unit (IB)≤3% by mol
39% by mol≤structural unit (IB)≤71% by mol
13% by mol≤structural unit (II)≤30% by mol
2% by mol≤structural unit (IIIA)≤6% by mol
11% by mol≤structural unit (IIIB)≤24% by mol.

6. The liquid crystal polyester resin according to claim 1, wherein the structural unit (II) derived from an aromatic diol compound is a structural unit derived from 4,4′-dihydroxybiphenyl.

7. A fibrous molded article comprising the liquid crystal polyester resin according to claim 1.

8. An injection molded article comprising the liquid crystal polyester resin according to claim 1.

9. An electrical/electronic component comprising the molded article according to claim 7.
